(19) United States
(12) Patent Application Publication
(10) Pub. No.: US 2021/0381885 A1
(43) Pub. Date: Dec. 9, 2021

(54) LIGHT-EMITTING ELEMENT INSPECTION DEVICE

(71) Applicant: PEGATRON CORPORATION, TAIPEI CITY (TW)

(72) Inventors: Shao-Han Chiang, Taipei City (TW); Tzu-Hsiang Kao, Taipei City (TW); Tsung-Wei Tseng, Taipei City (TW); Wen-Shau Peng, Taipei City (TW); Jyun-Yi Wu, Taipei City (TW); Hsin-Han Chen, Taipei City (TW); Ting-Yi Wu, Taipei City (TW); Hsiao-Jung Ou, Taipei City (TW); Wei-Fu Chen, Taipei City (TW); Chih-Yuan Lin, Taipei City (TW); Li-Chia Wang, Taipei City (TW)

(73) Assignee: PEGATRON CORPORATION, TAIPEI CITY (TW)

(21) Appl. No.: 17/214,523

(22) Filed: Mar. 26, 2021

(30) Foreign Application Priority Data
Jun. 4, 2020 (TW) 109118771

(51) Int. Cl. G01J 1/42; G01J 1/04

(52) U.S. Cl. CPC G01J 1/42; G01J 2001/4252; G01J 1/0425

(57) ABSTRACT

The disclosure provides a light-emitting element inspection device optically connected to at least one light-emitting element of a test object and including a dark box, a slide rail, an image-capturing device, a light-entrance plate, and a processor. The slide rail and the image-capturing device are disposed in the dark box. The image-capturing device slides on the slide rail. The light-entrance plate is disposed on one side of the dark box and has at least one hole optically connected to the light-emitting element. The image-capturing device is aligned with the light-entrance plate to capture an image of the light-entrance plate. The processor is coupled to the image-capturing device and is adapted to obtain a set of RGB values of the image, convert the RGB values into a set of HSV values, and determine whether the light-emitting element of the test object conforms to a standard based on the HSV values.

### CROSS-REFERENCE TO RELATED APPLICATION

This application claims the priority benefit of Taiwan application serial no. 109118771, filed on Jun. 4, 2020. The entirety of the above-mentioned patent application is hereby incorporated by reference herein and made a part of this specification.

### BACKGROUND

### Technical Field

The disclosure relates to a light-emitting element inspection device, particularly to a light-emitting element inspection device adapted to execute an intelligent color mixing identification system according to hue purity of light-emitting diode.

### Description of Related Art

Conventional light-emitting diode (LED) testing uses a simple test fixture. After the product is connected to the power supply and turned on, the optical fiber cables in the fixture conduct the light source to the display panel of the fixture to determine whether the product functions normally through visual inspection of operators. The test items include number, color, and luminance of the light-emitting diodes.

In the traditional inspection method, when the tests are conducted by operators, different judgment standards of the operators or the influence of environmental factors often lead to misjudgments in color, luminance, quantity among others.

### SUMMARY

The present disclosure proposes a light-emitting device capable of determining automatically whether the light-emitting device to be tested conforms to the standard, and reducing the misjudgment due to different judgment standards of workforce or the influence of environmental factors.

The disclosure provides a light-emitting element inspection device optically connected to at least one light-emitting element of a test object. The light-emitting element inspection device includes a dark box, a slide rail, an image-capturing device, a light-entrance plate, and a processor. The slide rail is disposed in the dark box. The image-capturing device is disposed in the dark box and is disposed slidably on the slide rail. The light-entrance plate is disposed on one side of the dark box and has at least one hole. The hole is optically connected to the light-emitting element to make light emitted by the at least one light-emitting element exposed from the at least one hole. The image-capturing device is aligned with the light-entrance plate to capture an image of the light-entrance plate. The processor is coupled to the image-capturing device and is adapted to obtain a set of RGB value of the image that corresponds to the light-emitting element, convert the RGB value into a set of HSV value, and determine whether the light-emitting element of the test object conforms to a preset standard according to the HSV value.

Based on the above, the present disclosure determines automatically whether the light-emitting element to be tested conforms to the preset standard based on the image taken in the dark box, which reduces greatly the misjudgment made due to different judgment standards of the operators or the influence of environmental factors.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view of the configuration of a light-emitting element inspection device according to an embodiment of the present disclosure.

FIG. 2 is a schematic view of an image-capturing device at one end of the slide rail according to an embodiment of the present disclosure.

FIG. 3 is a schematic view of an image-capturing device at one end of the slide rail according to an embodiment of the present disclosure.

FIG. 4 is a schematic view of a light-entrance plate's image captured by the image-capturing device according to an embodiment of the present disclosure.

FIG. 5 is a flow chart of the process of a method of the color mixing identification system for hue purity of the light-emitting element according to an embodiment of the present disclosure.

### DESCRIPTION OF THE EMBODIMENTS

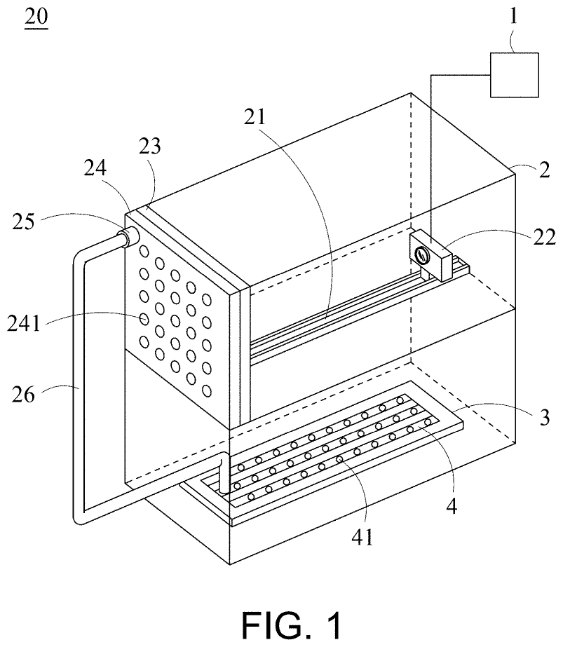

In FIG. 1, a light-emitting element inspection device 20 according to an embodiment of the present disclosure is optically connected to at least one light-emitting element 41 of a test object 4 to inspect the light-emitting element 41. The light-emitting element inspection device 20 includes a dark box 2, a slide rail 21, an image-capturing device 22, a light-entrance plate, 24 and a processor 1.

The slide rail 21 is disposed in the dark box 2. The image-capturing device 22 is disposed in the dark box 2 and is disposed slidably on the slide rail 21. In this embodiment, the dark box 2 is a hollow rectangular parallelepiped, and the slide rail 21 is disposed on an inner bottom surface of the dark box 2 and parallel to a long axis of the rectangular parallelepiped. The image-capturing device 22 moves in a direction parallel to the long axis of the rectangular parallelepiped inside the dark box 2 through the slide rail 21.

The light-entrance plate 24 is disposed on one side of the dark box 2 and has at least one hole 241. The hole 241 is optically connected to the light-emitting element 41 to make light emitted by the light-emitting element 41 expose from the hole 241. For example, the relative position of the test object 4 and the light-entrance plate 24 may be adjusted so that the position of the hole 241 can be directly aligned with the position of the light-emitting element 41, such that the light emitted from the light-emitting element 41 enters the hole 241 directly. For another example, the light of the light-emitting element 41 is guided to the hole 241 through an optical fiber 26 to establish an optical connection between the light-emitting element 41 and the hole 241. However, the present disclosure is not limited thereto. Although there is only one light-emitting element 41 optically connected to one hole 241 through the optical fiber 26 in FIG. 1, in practical operation, each light-emitting element 41 is optically connected to the corresponding hole 241 on the light-entrance plate 24 via the optical fiber 26. The only one optical fiber 26 shown in FIG. 1 is for the purpose of keeping the drawing simple and clear, and thus other optical fibers 26 are omitted herein.

The image-capturing device 22 is aligned with the light-entrance plate 24 in the dark box 2 to capture an image of the light-entrance plate 24. Since the light emitted by the light-emitting element 41 is guided to the hole 241 formed on the light-entrance plate 24 while there is no other light in the dark box 2. Thus the light-emission condition of the light-emitting element 41 can be observed more accurately through the image captured by the image-capturing device 22 in the dark box, reducing the interference from environmental factors greatly.

The processor 1 is coupled to the image-capturing device 22, and is adapted to obtain a set of RGB value of the image that corresponds to each light-emitting element, convert the RGB value into a set of HSV value, and determine whether the light-emitting element 41 of the test object 4 conforms to a preset standard according to the HSV value. R, G, and B in the RGB value respectively refer to red, green, and blue, whereas H, S, and V in the HSV value respectively refer to hue, saturation, and value (or lightness). The preset standard may include a lightness standard, a saturation standard, a hue standard, and a quantity standard. In this embodiment, the processor 1 may be a general-purpose computer with a central processing unit and a storage device for storing software codes that perform the image processing steps described later. Alternatively, the processor 1 may be an electronic device with specific application functions, capable of performing the image processing steps described later. Since the image captured by the image-capturing device 22 is expressed in RGB value, it is difficult to directly tell from the numerical value whether the light-emission condition displayed in the image after the hole 241 receives the light of the light-emitting element 41 conforms to the standard. Therefore, the processor 1 first converts the RGB value into the HSV value in the HSV color model, so as to directly determine based on the lightness value, hue value, and saturation value in the HSV color model.

In an embodiment of the present disclosure as shown in FIG. 1, the light-emitting element inspection device 20 further includes a pipe connector 25 adapted to connect the optical fiber 26 to the hole 241. The pipe connector 25 is made of elastic materials and is substantially hollow cylindrical with an inner diameter slightly smaller than the diameter of the optical fiber 26, such that the two fit tightly after the optical fiber 26 is inserted. The outer diameter of the pipe connector 25 is slightly larger than the hole diameter of the hole 241, so as to fit tightly with the hole 241 after being inserted into the hole 241. Through the pipe connector 25, most of the light guided by the optical fiber 26 enters the hole 241, so as to reduce greatly light leakage. In addition, with the pipe connector 25, it is also easier for the operator to insert the optical fiber 26 into the hole 241 or to pull it out from the hole 241.

In an embodiment of the present disclosure, the light-entrance plate 24 may be made of a light-absorbing material, such as black bakelite. The use of light-absorbing materials reduces the reflection of light in the dark box 2 after the light enters the dark box 2 from the hole 241 of the light-entrance plate 24. This configuration improves the accuracy of inspection.

The light-emitting element inspection device 20 further includes a fiber verification plate 23 disposed at the light-entrance plate 24 and located in the dark box 2. The fiber verification plate 23 may be made of a translucent material, and may be provided to be separated from the light-entrance plate 24 by a distance. When different optical fibers 26 are inserted into the holes of the light-entrance plate 24, the fibers are blocked by the fiber verification plate 23 on the same plane, and the light emitted is uniformized by the fiber verification plate 23. This way, the image quality captured by the image-capturing device 22 is further improved.

In an embodiment of the present disclosure as shown in FIG. 1, the light-emitting element inspection device 20 may further include a fixture 3 adapted to fix the test object 4 to the dark box 2. The fixture 3 may slide from a preparation position to a test position. When the fixture 3 slides to the preparation position, the operator may place and fix the test object 4 on the fixture 3, and then slide the fixture 3 to the test position. When the fixture 3 slides to the test position, the end surface of the optical fiber 26 is aligned with the light-emitting element 41 to guide the light of the light-emitting element 41 to the light-entrance plate 24 to establish an optical connection between the hole 241 of the light-entrance plate 24 and the light-emitting element 41.

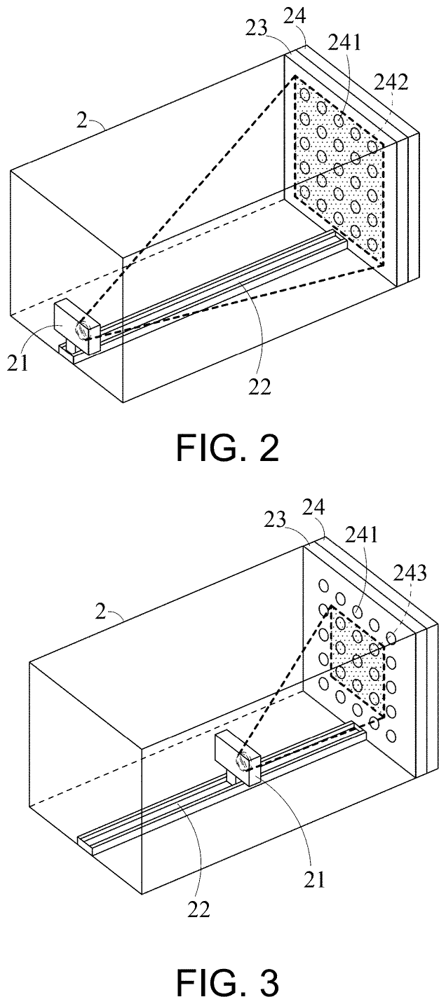

In an embodiment of the present disclosure, the numbers of the light-emitting element 41 and the hole 241 may both be plural. In some embodiments, the numbers of the light-emitting element 41 and the hole 241 may be the same. Based on different environmental settings, through the slide rail 21, the image-capturing device 22 may adjust the shooting distance between itself and the light-entrance plate 24 as well as the size of the region of interest (ROI) captured by the image-capturing device 22. In FIG. 2 and FIG. 3, the light-entrance plate 24 may include 5×5 holes 241. When the image-capturing device 22 is located farther from the light-entrance plate 24, the image-capturing device 22 captures a larger region of interest, covering all 5×5 holes 241. When the image-capturing device 22 is adjusted to a position closer to the light-entrance plate 24 through the slide rail 21, the region of interest captured by the image-capturing device 22 becomes smaller, covering only the 3×3 holes 241. With this configuration, when the test object 4 has more light-emitting elements 41, the image-capturing device 22 can be slid to a position to have a larger region of interest. When the test object 4 has less light-emitting elements 41, the image-capturing device 22 can be slid to a position where the region of interest is smaller. The processor 1 may further calculate the quantitative value of the light-emitting elements 41 according to the captured image of the region of interest, and based on the quantitative value to determine whether the test object 4 conforms to a quantity standard, that is, whether each light-emitting element 41 included in the test object 4 emits light normally.

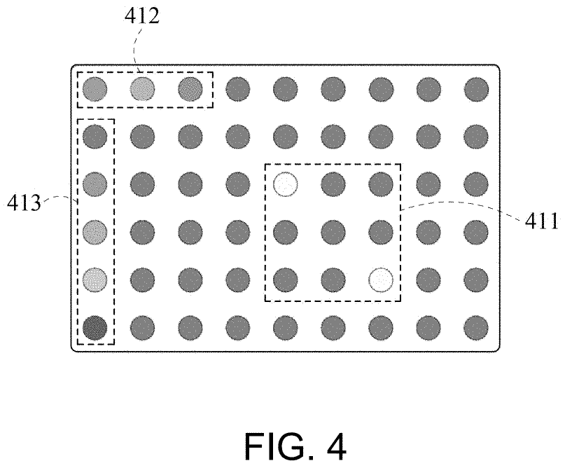

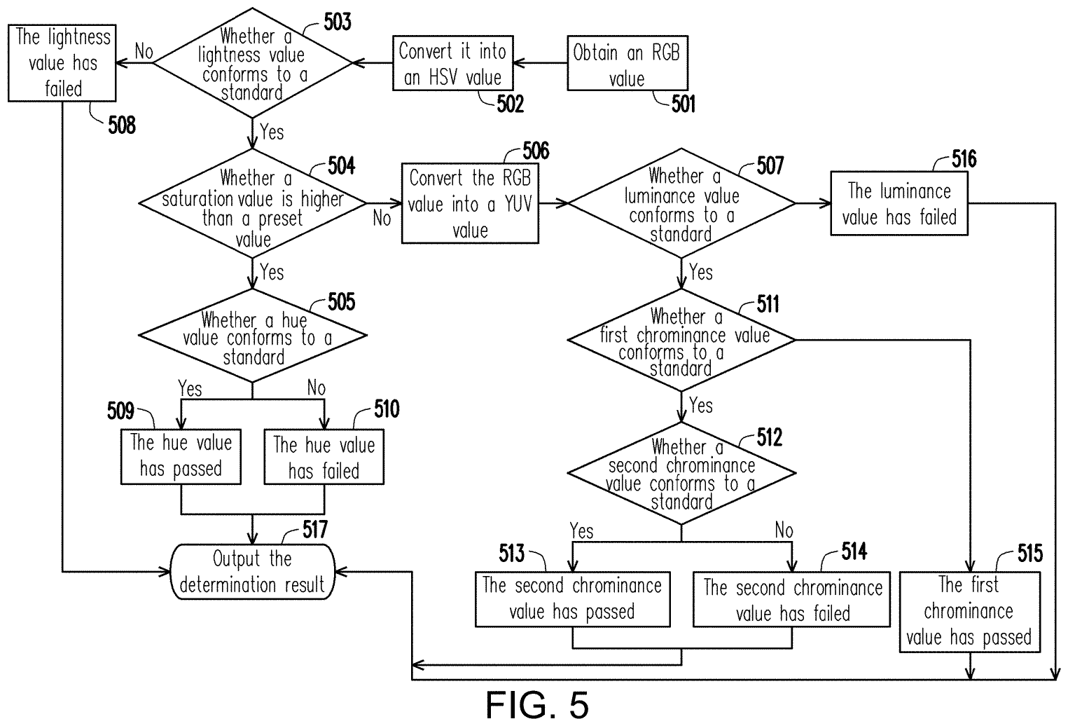

Please refer to FIG. 4 and FIG. 5. FIG. 4 shows the light-emission condition of the light-emitting element 41 in the region of interest captured by the image-capturing device 22, and FIG. 5 shows the flow of the method for inspecting the light-emitting element 41 executed by the processor 1. First, in step 501 and step 502, the processor 1 obtains the image captured by the image-capturing device 22, and converts the RGB value of each light-emitting element 41 in the image into a corresponding value of an HSV color model. The processor 1 may be a general-purpose computer adapted to be installed with and execute a light-emitting element identification software, and the image-capturing device 22 may transmit the RGB value of the image through a wired or wireless communication protocol.

After the processor 1 receives the RGB values of each light-emitting element 41 in the image, it may execute the light-emitting element identification software to perform the numerical conversion between the RGB value and the HSV color model. In this embodiment, since a light-emitting element 41 may correspond to multiple pixels in the image captured by the image-capturing device 22, and each pixel has a corresponding set of RGB value, the processor 1 may first obtain the average value of the RGB values of all pixels in the image corresponding to the light-emitting element 41 to be regarded as the RGB value of the light-emitting element 41, and then perform the conversion of the corresponding value of the HSV color model. In another example, multiple sets of RGB values of multiple pixels corresponding to each light-emitting element 41 in the image may be first converted into multiple sets of corresponding values of the HSV color model, before obtaining the average value. Those who are familiar with this technology may take different approaches, and such modification does not go beyond the spirit and scope of the present disclosure.

In step 503, the processor 1 determines whether the lightness value of the light-emitting element 41 is lower than a lightness standard in a preset standard. For example, the lightness standard is set to 60%, and in area 411 of FIG. 4, there are two light-emitting elements 41 having a lightness value of 0%, and the other seven light-emitting elements 41 have a lightness value of 100%. At this time, the processor 1 determines that the two light-emitting elements 41 do not conform to the standard according to the preset luminance standard. In step 508, the states of the two light-emitting elements 41 are recorded as abnormal, and in step 513, the corresponding determination result are output. As for the remaining seven light-emitting elements 41 whose states are determined to be normal, the processor 1 performs other tests on them. In some embodiments, the processor 1 records the lightness value in the field corresponding to the abnormal light-emitting element 41 as abnormal, and the lightness value is 0%.

Next, in step 504, when the lightness value conforms to the preset standard, the processor 1 further determines its saturation. When the processor 1 determines that the saturation value of the pixel corresponding to the light-emitting element 41 in the captured image is lower than a saturation standard of the preset standard, it is determined to be achromatic. In other words, the light emitted by the corresponding light-emitting element 41 is grayscale light. For example, the range for the saturation value is 0 to 255, and the saturation standard is 100. If the processor 1 detects that the saturation value of the light-emitting element 41 is 50, it determines that the light emitted by the light-emitting element 41 is achromatic grayscale light.

When the processor 1 detects that the saturation value of the light-emitting element 41 is higher than the saturation standard, step 505 is performed to determine the hue. In step 505, the processor 1 determines whether the state of the light-emitting element 41 is abnormal according to a hue standard of the preset standard. If the hue value of the light-emitting element 41 is higher than the hue standard, then it is recorded in step 509 as passing the test for the hue value, and if it is lower than the hue standard, it is recorded in step 510 as failing the test for the hue value.

When the processor 1 determines in step 504 that the light emitted by the light-emitting element 41 is achromatic, the processor 1 may further proceed to step 506 to convert the RGB value of the image into a corresponding value in the YUV color model. Y, U, and V in the YUV color model respectively represent luminance, the first chrominance, and the second chrominance. For example, in area 413 of FIG. 4, when the processor 1 determines that a plurality of light-emitting elements 41 are achromatic light-emitting elements 41 through the HSV color model, it further converts the RGB values into corresponding values of the YUV color model. In step 507, the processor 1 determines whether the luminance value of the light-emitting element is black, white, or gray according to a preset luminance standard, and whether it conforms to the standard. For example, when the luminance value is 0, it is determined that the light-emitting element is black; when the luminance value is 1, it is determined that the light-emitting element is white; when the luminance value is between 0 and 1, it is determined that the light-emitting element is gray. If the preset luminance standard is 0.8, then for the light-emitting element 41 having a luminance value greater than 0.8, it is recorded in step 507 as passing the test for the luminance value; and for the light-emitting element 41 whose luminance value is equal to or lower than 0.8, it is recorded in step 512 as failing the test for the luminance value.

When the processor 1 determines in step 507 that the light emitted by the light-emitting element 41 conforms to the luminance standard, it proceeds to step 511 to determine whether the first chrominance value of the light-emitting element 41 conforms to a first chrominance standard of the preset standard. If the first chrominance value of the light-emitting element 41 conforms to the first chrominance standard, step 512 is performed to determine whether the second chrominance value of the light-emitting element 41 conforms to a second chrominance standard of the preset standard. If the first chrominance value of the light-emitting element 41 does not conform to the first chrominance standard, it is recorded in step 515 as failing the test for the first chrominance value. If the second chrominance value of the light-emitting element 41 does not conform to the second chrominance standard, it is recorded in step 514 as failing the test for the second chrominance value. If the first chrominance value and the second chrominance value of the light-emitting element 41 both conform to the preset standards, it is recorded in step 513 as passing the tests for the first chrominance value and the second chrominance value.

In this embodiment, various determination results of multiple light-emitting elements 41 may be visualized and output collectively in step 513. For example, the processor 1 outputs the lightness values of multiple light-emitting elements 41 into a visualized broken line graph, so that the inspector can figure out which light-emitting element has a problem. The processor 1 may also output different charts at one time, such as outputting line charts of the lightness value, hue value, and luminance value at the same time, so as to facilitate the inspector to further analyze the cause of error.

Based on the above, the present disclosure determines automatically whether the light-emitting element to be tested conforms to the preset standard based on the image taken in the dark box, which reduces greatly the misjudgment made due to different judgment standards of the operators or the influence of environmental factors.

Although the present disclosure has been described with reference to the above embodiments, it will be apparent to one of the ordinary skill in the art that modifications to the described embodiment may be made without departing from the spirit of the disclosure. Accordingly, the scope of the disclosure will be defined by the attached claims not by the above detailed descriptions.

What is claimed is:

1. A light-emitting element inspection device, optically connected to at least one light-emitting element of a test object for inspecting the at least one light-emitting element, the light-emitting element inspection device comprising:
a dark box;
a slide rail, disposed in the dark box;
an image-capturing device, disposed in the dark box and disposed slidably on the slide rail;
a light-entrance plate, disposed on one side of the dark box, and comprising at least one hole, wherein the at least one hole is optically connected to the at least one light-emitting element to make light emitted by the at least one light-emitting element expose from the at least one hole, the image-capturing device is aligned with the light-entrance plate for capturing an image of the light-entrance plate; and
a processor, coupled to the image-capturing device, and configured to:
obtain an RGB value corresponding to each of the at least one light-emitting element in the image;
convert the RGB value of each of the at least one light-emitting element into an HSV value; and
determine whether each of the at least one light-emitting element of the test object conforms to a preset standard based on the HSV value.

2. The light-emitting element inspection device according to claim 1, wherein the preset standard comprises a saturation standard in an HSV color model, and the processor is further configured to:
determine whether a saturation value of the HSV value is lower than the saturation standard;
if yes, convert the HSV value into a YUV value; and
determine whether the at least one light-emitting element of the test object conforms to the preset standard based on the YUV value.

3. The light-emitting element inspection device according to claim 1, wherein the RGB value of the at least one light-emitting element is an average value of a plurality of RGB values of a plurality of pixels in the image corresponding to the at least one light-emitting element.

4. The light-emitting element inspection device according to claim 1, wherein the preset standard comprises a luminance standard, a saturation standard, a chrominance standard, and a quantity standard.

5. The light-emitting element inspection device according to claim 1, wherein numbers of the at least one light-emitting element and the at least one hole are plural, and the processor further calculates a quantity value of the at least one light-emitting element based on the image and determines whether the test object conforms to a quantity standard based on the quantitative value.

6. The light-emitting element inspection device according to claim 1, further comprising at least one optical fiber configured to optically connect between the at least one light-emitting element and the at least one hole of the light-entrance plate.

7. The light-emitting element inspection device according to claim 3, further comprising a pipe connector configured to connect the at least one optical fiber to the at least one hole.

8. The light-emitting element inspection device according to claim 3, further comprising a fixture configured to fix the test object to the dark box, wherein the fixture is configured to slide from a preparation position to a test position; and when the fixture slides to the test position, the at least one optical fiber is optically connected to the at least one light-emitting element.

9. The light-emitting element inspection device according to claim 1, wherein the light-entrance plate is black bakelite.

10. The light-emitting element inspection device according to claim 1, further comprising a fiber verification plate disposed at the light-entrance plate and located on an inner side of the dark box.
